(19) United States
(12) Patent Application Publication
(10) Pub. No.: US 2006/0251788 A1
(43) Pub. Date: Nov. 9, 2006

(54) Nutritional product and hydration method of manufacture

(75) Inventor: Michael G. Angel, Temecula, CA (US)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(73) Assignee: Mighty Oats, Inc., Temecula, CA (US)

(21) Appl. No.: 11/362,476

(22) Filed: Feb. 23, 2006

Related U.S. Application Data
(63) Continuation-in-part of application No. 11/123,472, filed on May 5, 2005.

(51) Int. Cl. A21D 10/00

(52) U.S. Cl. 426/549

(57) ABSTRACT

Food product and system and method of making it in is provided in which the product includes a hydrated plurality of grain or seed based constituents. In a preferred embodiment the product can be prepared by selecting one or more grain or seed based constituents, hydrating to a desired softness, then packaging and freezing. Optionally hydration is performed under reduced-pressure conditions.

### CROSS-REFERENCE TO RELATED APPLICATIONS

This application is a continuation-in-part of U.S. patent application Ser. No. 11/123,472, filed May 5, 2005, entitled “Nutritional Product and Hydration Method of Manufacture,” which is incorporated in its entirety by reference herein.

### FIELD OF THE INVENTION

The present invention relates to a grain or seed food product that is manufactured using hydration and/or freezing, and to a food product prepared for consumption by thawing. The food product optionally is a time released nutritional product containing components that are digested at different rates providing nutritional value over different periods of time.

### BACKGROUND OF THE INVENTION

Various types of ready-to-eat and cooked cereal products are known. For example, various processed cereal products are known. Such cereal products frequently are made of uniformly processed grains that typically include a processed flour form, which is formed into a desired shape, and baked, toasted or otherwise pre-prepared. Various additives such as sugar or dried fruits are added. Among such processed cereal food products are “Cheereos” or “Wheaties” from General Mills Corp., located in Minneapolis, Minn.

Various forms of cereal products to be cooked are also known. One example is oatmeal, which typically includes a dry form of rolled oats, which is prepared by adding water and then boiled for a period of time until a desired consistency is achieved. One example of an oatmeal product is “Quaker Oats” available from The Quaker Oats Company, Chicago, Ill. Cereal products such as this that are available in a dry form and meant to be cooked will be referred to herein as “cooked cereal” products.

Some ready-to-eat and cooked cereal products have a disadvantage in that the product is digested over a relatively short period of time. For examples cereal products made of a grain or grains that is/are processed in a single way tend to be digested within a given time period. Easy to digest flour based products can typically be digested over a relatively short period of time. With such a product one tends to get hungry relatively quickly after eating. Various known ready-to-eat and cooked cereal products suffer this disadvantage.

One known cereal product directed to providing a longer period of digestion is described in U.S. Pat. No. 5,759,612. The product is meant to be digested over an extended period of time providing for the release of energy over an extended period of time. Components of varying levels of fiber and degree of cook are selected. However, this product suffers a number of disadvantages, including that preparation requires several different cooking steps under different preparation conditions, such as preparing different components in separate batches.

De-hulled whole grain oats, known as groats, have various known nutritional benefits including high fiber, and relatively slow digestion times. Likewise bumped oat groats, which are lightly processed groats have relatively slow digestion times. Other forms of oats, such as cut oats also have some of these benefits, but a generally faster digestion time than groats, but still slower than rolled oats. One disadvantage of a cooked or liquid cereal product including groats, bumped oats, or cut oats is that a relatively long cooking time is required in order to soften the groats sufficiently to be swallowed with ease. Without sufficient softening, the groat or steel cut oat can remain relatively hard and undesirable for human consumption.

Hot grain cereals on the market today typically provide only one milling process (i.e. rolling) and therefore a uniform digestion process that does not regulate carbohydrate or other nutrition delivery times, nor do they typically provide different grain milling types that have different digesting times and carbohydrate delivery.

In addition hot grain cereals are not known to provide fresh fruit or frozen fruit, unless added by the consumer prior to eating.

In addition, intact whole grain (i.e. with or without hulls, but including the testa or seed coating) is considered to provide health benefits, such as including naturally occurring nutrients and phytochmicals. However, the above-discussed products suffer a disadvantage in that they typically cannot make use of whole unprocessed grains, which are viewed as not susceptible of inclusion in a commercial product, without at least some processing.

It is understood that the high and frequent pervasive consumption of high glycemic index foods in common modem diets can result in various health problems, such as obesity and type 2 diabetes. Furthermore, high-glycemic index diets result in high levels of insulin, which increase hunger and favor fat deposition. Staving off a hungry feeling is understood to be one reason for obesity, in which a hungry feeling results in further food consumption. Low satiety occurring with high-glycemic index foods translates into significantly increased food and calorie consumption leading to weight gain in many people. Satiety is a function of several food attributes: the glycemic index, level of dietary fiber, starch resistance, digestion time, and carbohydrate availability or delivery.

Various methods of manufacture or preparation of grain or seed based food products are known. In one method of manufacture warm breakfast cereals are manufactured by packaging grains or seeds (or other additives) in containers for distribution to consumers. The consumer prepares the cereal by adding a fluid such as water and/or milk and accelerating the fluid infiltration of the cereal constituents by application of heat for a designated period of time. In one known method, water is measured and mixed with the product and boiled for a designated period of time. In another known method a consumer positions the product in already boiling water. In another known method the product is mixed with water in a bowl and microwave heated for a period of time. These methods suffer various disadvantages, including requiring the application of heat to assist with fluid infiltration and resultant increased energy costs and risk of injury from handling boiling water. Other disadvantages are involved in the increased requirements of handling, such as in measuring the fluid, adding it in, and positioning the combination in a microwave or on a stove.

In another method of manufacture, the grain or seed based food product is freeze dried in manufacture. The consumer re-hydrates the product for consumption. This technique also suffers disadvantages of involving increased manufacturing expense in the freeze-drying process. Preparation also has the disadvantage of involving adding in a fluid for re-hydration.

Further disadvantages of hot cereals or hot soup products is that nutrient loss or particle breakdowns can occur during the cooking process. Other disadvantages of known products is that a single serving generally does not meet recommended levels of fruit and whole grain, such as recommended in the FDA food pyramid recommendations.

Accordingly, there exists a need for a liquid or cooked food product that can be prepared without the addition of a fluid by the consumer in preparation and/or without enhanced fluid infiltration, nutrient losses or particle breakdowns by way of the application of heat in cooking. There also exists a need for a frozen food product that provides in a single serving recommended levels of fruit and whole grains.

### SUMMARY OF THE INVENTION

The present invention alleviates to a great extent the disadvantages of known cereal and grain or seed products by providing a pre-hydrated cereal or grain and/or seed product that can be prepared by the consumer such as by opening a container or by heating to a desired temperature. In fabrication, the grain and/or seed constituents preferably are hydrated by positioning the constituents in a fluid bath for a desired period of time, and then packaging the product for shipment, such as by freezing. Optionally, the product can be heated and stored in a vacuum-sealed container and thereby be packaged in a fluidized state. As a further option, a pressure modification system is provided in order to conduct the hydration in a pressure-modified environment, such as a low pressure or vacuum environment. A consumer can open the container, and in the frozen embodiment thaw prior to consumption. Optionally, the consumer can thaw by applying heat from an external source and optionally raise the temperature to an elevated level to have a “hot” cereal for consumption.

In a preferred embodiment, the food product is a time released nutritional product that includes a plurality of grain or seed based constituents having plural digestion rates, such as described in U.S. patent application Ser. No. 10/457,089, entitled “Time Released Nutritional Product and Method of Manufacture”, and in U.S. patent application Ser. No. 11/063,390, entitled “Time Released Nutritional Product and Method Of Manufacture”, the contents of both of which are incorporated herein by reference. In an alternative embodiment, one or more grain constituents and/or seed constituents of similar digestion rates are used, or alternatively are combined with other grains and/or seeds of differing digestion rates. In any of the embodiments, other constituents can be included such as fruits, sugars, syrup etc. It should be appreciated that the term “fruit” as used herein is intended to include fruits and vegetables.

In an embodiment, differing percentages of constituent parts are provided. The constituent parts may be one or more grain (or other type of seed) processed in one or more ways. As one example, one such food product includes different forms of oats combined together, such as part groats and/or part bumped groats and/or part steel cut oats and/or part rolled oats. It should be noted that each milling process can vary as well. For example in the bumped groats, differing degrees of bump can be selected. Likewise in the rolled oats, differing rolling distances can be selected. The different constituent parts are selected to provide particular ranges of digestion or nutrition delivery rates.

In one example, the constituent parts include oats processed by a combination of three different ways: rolled (a flake product of selected thicknesses distances), steel cut (slices of whole grains of selected slice sizes), bumped groats and groats (de-hulled whole grain oats). Percentages of each of the three different processed oat products are combined. Rolled oats are digested relatively quickly providing relatively quick energy and nutrition delivery, steel cut oats are digested at a relatively slower rate, over a medium length of time, bumped groats and groats are digested a still longer period of time thus providing extended nutrition and energy delivery. Whole grains can be used as well.

In manufacture of a preferred food product, fluid, such as water or other hydrating fluid such as milk or various combinations of milk, water and/or juices are combined with the dry constituents. The mixture is allowed to hydrate for a period of time and other constituents can be added as well, such as honey, powdered milk, soy products, fruit (for examples strawberries, blueberries, cranberries, citrus etc., or combinations thereof). These added constituents can be added at any desired stage before, during or after hydration. The hydrated product then optionally is frozen or packaged and subsequently frozen. In an embodiment in which fresh fruit or fresh frozen fruit is added following hydration (i.e. after or at the end of the hydration period), fresh frozen fruit is provided to the consumer. For consumption, the consumer thaws the product prior to eating, optionally with the aid of applied heat, such as via a microwave.

It should be noted that in other embodiments, various combinations of other grains or seeds can be used, such as wheat, corn, barley, flax, maize etc. various combinations of processing methods are used. In another embodiment, the hydration process may be performed in a pressure-modified environment, such as in a low-pressure or vacuum system. In still further embodiments, cooking or partial cooking of the grain constituents is performed instead of or in addition to hydration. These processes can serve to decrease the hydration period. In addition, fresh fruit or fresh frozen fruit can be added prior to freezing creating a frozen food product containing fruit and in one alternative, which meets the FDA recommendations for fruit and whole grains in a single serving.

In other embodiments, a hot or liquid food product is provided in which the product is heated following packaging. In one example a soup product is heated. In another a hot cereal product is provided. In one embodiment, a period of time is selected for the heating of products containing a grain, in which loose starch particles form a gelatinous composition coating the pieces of the other constituents, rendering them more swallowable than they otherwise would be.

Besides cereal mixtures, other forms of time released food products and carbohydrate delivery systems are provided in accordance with the present invention. For example, soups, pre-prepared hot breakfast cereals, food additives to other foods, cookies, energy/nutrition bars, waffles, bread dough, etc. can be prepared in accordance with the invention. In another example, the food product is prepared and then stored for consumption at a later time, such as by being freeze dried or otherwise dehydrated after hydration. In this way, the food product can be packaged or otherwise stored in the dehydrated form for consumption at a later time in which it can be rapidly re-hydrated for consumption by adding fluid and optionally heating. Advantageously, for grain based embodiments of the food product, the particle size is relatively large such as compared to instant grain cereals, so it is possible to freeze dry (or dehydrate) the food product and subsequently reconstitute it and maintain particle integrity, and a relatively low glycemic index. In some embodiments, the food composition of the present invention can be used to provide a time released or otherwise regulated delivery of nutritional elements for uses as a diabetes treatment, for uses in dieting and in treatment of obesity.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a flowchart illustrating a method of making a food product in accordance with the present invention;

FIG. 2 is a flowchart illustrating a method of preparing a food product for consumption in accordance with the present invention;

FIG. 3 is a flowchart illustrating a method of making a food product in accordance with the present invention;

FIG. 4 is a flowchart illustrating a method of making a food product in accordance with another embodiment of the present invention;

FIG. 5 is a flowchart illustrating a method of making a food product in accordance with the present invention;

FIG. 6 is a flowchart illustrating a method of making a packaged food product in accordance with another embodiment of the present invention;

FIG. 7 is a flowchart illustrating a method of making a packaged food product in accordance with another embodiment of the present invention;

FIG. 8 is a flowchart illustrating a method of making a packaged food product in accordance with another embodiment of the present invention;

FIG. 9 is a schematic illustration of a hydration system in accordance with an embodiment of the present invention;

FIG. 10 is a perspective view of a packaged food product in accordance with an embodiment of the present invention; and

FIG. 11 is a perspective cross-sectional view of a food product in accordance with another embodiment of the present invention.

### DETAILED DESCRIPTION OF THE PREFERRED EMBODIMENTS

In the following paragraphs, the present invention will be described in detail by way of example with reference to the attached drawings. Throughout this description, the preferred embodiments and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s). The terms “food product” and “food composition” of the present invention refer to an embodiment of the present invention suitable for consumption by a consumer, either with further preparation such as by cooking, heating or thawing, or without further preparation, although it should be understood that other embodiments of the present invention are in cooked or liquid form. The terms “food product” and “food composition” also refer to any end product including without limitation hydrated and frozen food products including or not including fresh frozen fruit, cereal constituents and frozen soups ready for consumption or heating.

Broadly speaking, in a preferred embodiment, the food product comprises a combination or mixture of a plurality of grain or seed based constituents having plural digestion or nutrition time release rates. However, it should be understood that in alternate embodiments, a single type of grain or seed based constituent is selected with one or more digestion or nutrient time release rate, or multiple grain or seed based constituents are selected with substantially similar digestion or nutrient time release rates. Although it is preferred that grains or seed be among the constituent ingredients, it is not required that they be included.

Following selection of the basic ingredients, the constituents preferably are hydrated and optionally other constituents are added either before, during or after hydration. The hydrated composition then is frozen prior to distribution or shipment to consumers.

By digestion or nutrition time release rates what is meant is that after eating, the nutritional elements are made available to the human body. Thus, in an embodiment including different types of grains or different preparations of grains, the different constituent parts provide plural time ranges in which the nutritional elements, for example carbohydrates are absorbed from the digestive tract thereby becoming available to the body. In one embodiment, the constituents include combinations of one or more grains or other seeds (or other constituents such as dried fruit), each processed or milled in one or more different processes yielding a food product having components with varying rates of digestion.

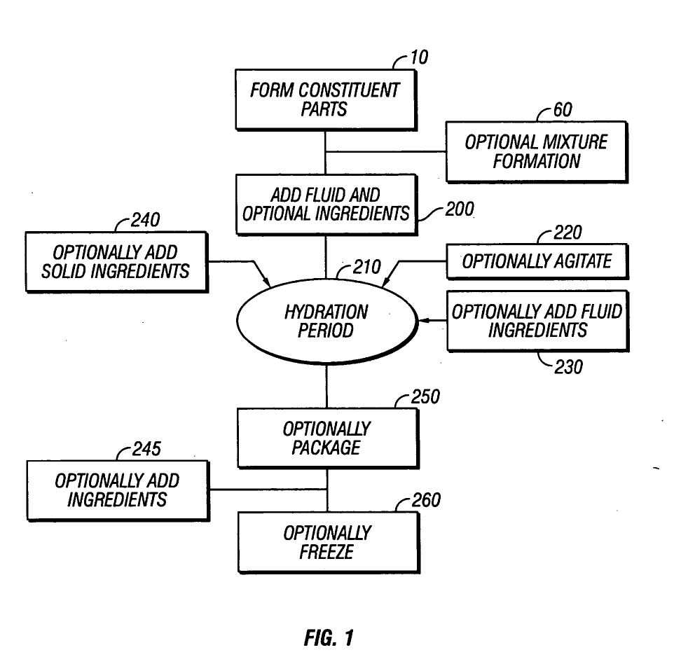

FIG. 1 provides a generalized description of a preferred method of manufacture. In the box identified with reference number 10, the types of constituents are selected. This includes selecting among different types of grains or seeds, such as for example, oats, rye, wheat, spelt, corn, flax, barley, etc. In an alternative embodiment, the constituents can include other types of food products, such as dried fruit, nuts, chocolate, etc. In addition, different forms of processing for the selected grains and seeds are selected in step 10. For example, ground flour, rolled, cut, bumped groats, kernel, whole grain or otherwise milled or physically modified grains and seeds. It should be noted that each of these processes can be selected with particular parameters for producing different constituent parts. For example, rolled grains can be produced at different roller separation settings yielding different width (i.e. thickness) flakes. Likewise, cut grains can be created with different width of cuts. Preferably the grains or seeds and processing methods are selected to achieve a cereal having constituents of differing digestion or nutrition release rates. In an alternate embodiment, either a single constituent is selected or multiple constituents are selected with similar digestion or nutrition delivery rates.

One or more constituents are selected, which when hydrated or cooked soften the grain or seed constituents. Preferably, the constituents are hydrated without applying heat so that the mixture is “cold-processed and wet.” An advantage to being “cold-processed” is that it avoids any constituent from being altered by the application of heat. The constituents can form a gelatinous composition that can coat one or more other constituents by making use of loose starch particles, such as when cooked by a consumer, if heating is desired, or during manufacture, if cooking or pre-cooking is performed as a part of the hydration step. So in this embodiment, the food product includes a plurality of constituents having more than one digestion, energy or nutrition delivery rate, and optionally includes a starch composition coating at least a portion of at least one of the constituent parts.

In an alternative embodiment, grain or seed constituents, including pre-processed flakes can be coated other than by gelatinous composition, such as by other relatively water impermeable or low permeability edible coating materials. In this way, the constituent parts are rendered more amenable for freezing, without necessarily being cooked or hydrated. In this way processed cereal flakes or other constituents can be included in or can be the major part of the frozen food product of the present invention. Likewise various combinations of grain and fruit combinations are envisioned as embodiments.

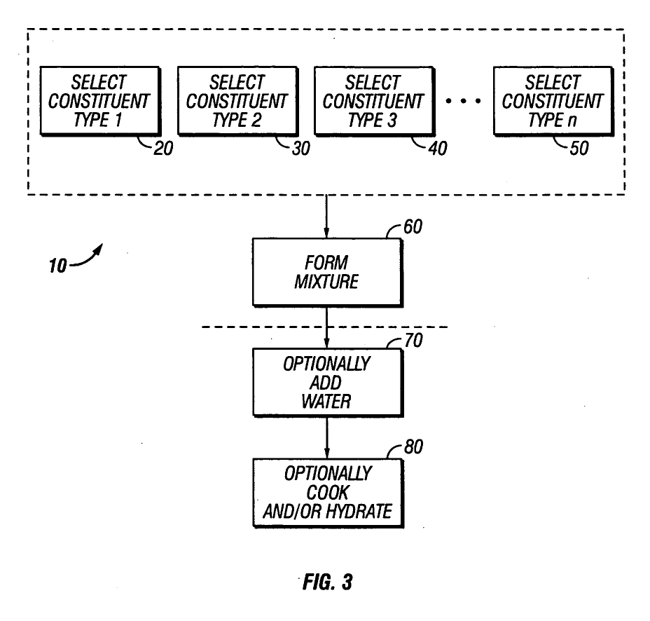

Selections of different constituents 10 are diagrammatically illustrated with the boxes identified with reference numerals 20, 30, 40 and 50, (shown in FIGS. 3, 5, 6 and 8) in which constituent 1, constituent 2, constituent 3 through constituent “n” are selected. Likewise, the percentages of each constituent are selected. In one example, only oats are selected as the grain and different forms of oats are used as the constituent parts. 1-99% rolled oats are selected, 1-95% groats are selected and 1-95% steel cut oats are selected. In another example, groats and two types of rolled oats are selected as three constituents. In this example, the rolled oats are split among one or more roller separation settings producing different width flakes. In another example, 1-90% ground wheat is selected, 1-99% rolled oats is selected. Thus it is seen that “n” can be any number over two as the number of constituent parts required to make a mixture and any percentages may be selected such that desired varied rates of absorption, time release or digestion are provided and also preferably that at least one of the constituents when cooked can form a gelatinous composition. It should be understood that although constituents may be selected before a hydration period 210, (shown in FIG. 1) it is not required that all of the constituents be hydrated. For example, fresh frozen fruit, chocolate, some nuts etc. are not required to be hydrated, and can be added at the end of or following hydration 210.

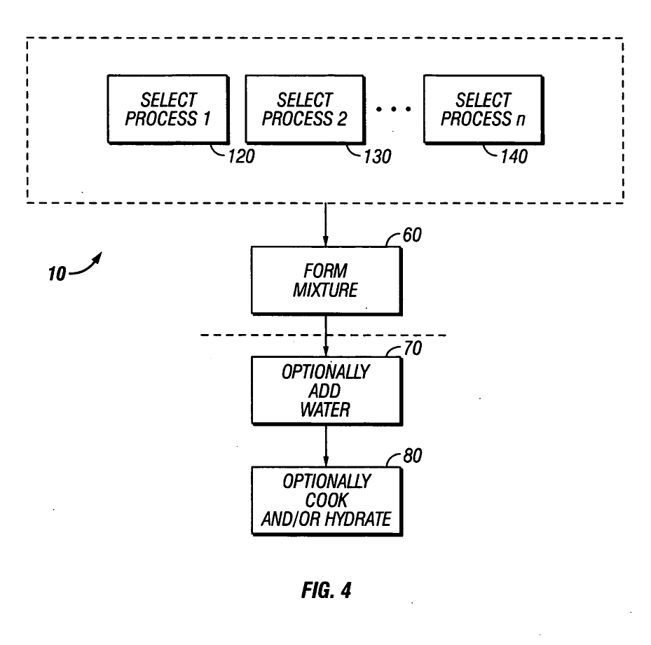

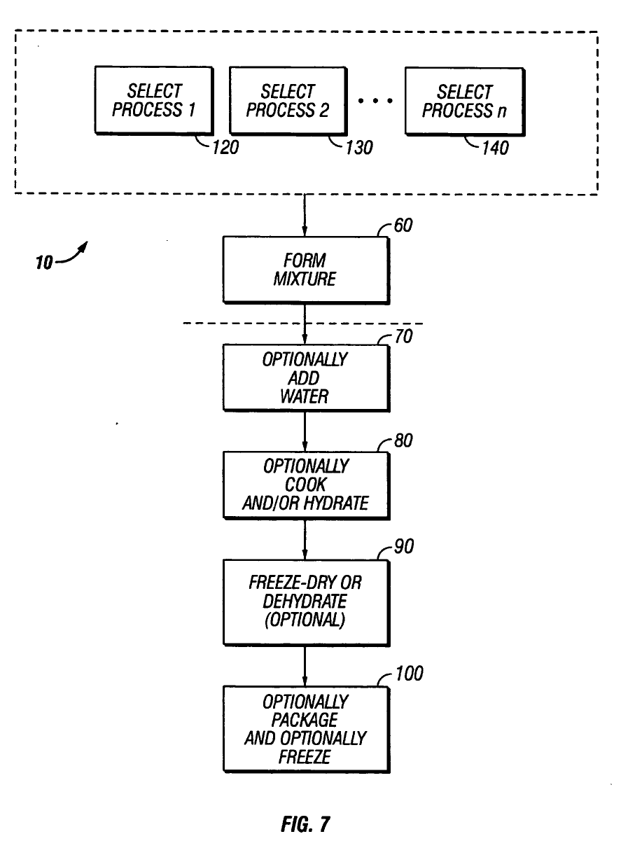

FIGS. 4 and 7 illustrate embodiments in which varied processes of manufacture of the grain constituents are selected in step 10. In box 120, process 1 is selected, in box 130, process 2 is selected and in box 140, process “m” is selected, in which “m” can be any number, including one or higher. For example if different grains are used, only a single processing step may be used. Alternatively, numerous different processes may be selected. In one alternative embodiment, the processing is performed, although pre-processed grains can be selected. It should be noted that any type of process can be selected suitable for the grain or seed, or alternatively no processing can be selected. For example, no processing would mean a whole grain or seed is selected for one of the constituent parts. So in this example, for instance, in one of steps 120, 130 or 140, no processing is selected as a “process”.

Following selection of the constituent parts and optionally percentages, a mixture is formed in step 60. It should be noted that forming a mixture also can be included in the step of forming constituent parts 10, and box 60 is used to diagrammatically illustrate this step that inherently may be performed as a part of step 10 as illustrated in FIG. 1. Accordingly, in FIG. 1, box 10 optionally includes mixing them into a mixture, which is preferred. It is not necessary to stir the constituent parts to form a uniform mixture, but doing so is preferred to provide some uniformity when portions are prepared. However, it should be noted that the constituent parts optionally can be mixed or otherwise agitated during hydration period 210 or while adding fluid 200 or adding fluid and optional ingredients. The constituent parts also can include partially cooked or fully cooked grain or seed constituents.

Following formation of the constituent parts 10, fluid is added as illustrated with box 200. The fluid preferably is water, but other fluids or combinations of fluids, such as milk, juice, honey, etc. can be provided. Different fluids, or additional amounts of fluids added in 200, can be added at other times, such as during the hydration period or afterwards. Box 200 is meant to illustrate the addition of fluids at any of these times. Optional ingredients also can be added at this stage, such as fruits and sugars.

Then the fluid/constituent parts combination is set for a period of time, called the hydration period 210. It is preferred that the amount of time allocated to the hydration period be any length of time necessary to hydrate the constituent parts a desired amount. If less hydration is desired a shorter period can be selected. If more hydration or softness is desired then a longer period or a different process may be selected. Generally speaking an ambienthydration period at ambient pressure and room temperature selected is between 5 and 15 hours and a preferred range is 10 to 12 hours or 9 to 13 hours, although short or longer periods can be selected depending on the amount of hydration desired and the particular constituents selected. It is not required to cook or heat during this period and room temperature processing is preferred. However, it should be understood that the hydration period can optionally be shortened by performing it at elevated temperatures or at different pressures. Any length of hydration period can be selected that achieves desired properties of the constituent parts, such as a desired softness or starch release level. Generally speaking it is preferred that the food composition have a palatable and digestible texture appealing to consumers following the hydration period 210. As used herein, the term “ambient hydration” is used to refer to hydration occurring at a temperature within a normal room temperature range such as between 40 and 110 degrees Fahrenheit, and may either be modified or at the unmodified room temperature, and at either ambient or reduced pressure conditions. The term “ambient-hydrated grains” refers to materials hydrated using ambient hydration. Although it should be understood that the hydration process of the present invention also can be performed at other below-boiling point temperatures.

In another embodiment, hydration period 210 is performed in a pressure-modified environment, such as under low-pressure or vacuum conditions. By performing the step under such conditions the hydration time may be reduced. In one example, it is reduced from the approximately 9 to 13 hours to a range of approximately 15 minutes to one hour, and preferably around 30 minutes at room temperature. The hydration time may be selected depending on the amount of vacuum provided, and temperature used. It should be appreciated, however, that any temperature may be used. The significant reduction in hydration time allows the product to be manufactured using either batch or continuous flow production methods, which allows added flexibility in production scheduling and capacity. In addition, as with the previously described hydration methods, the method of vacuum hydration provides hydrated constituents that remain generally intact and undamaged.

In one example of a pressure-modification system, pressure is reduced, or generally vacuum conditions are provided within a pressure kettle 112. Any pressure kettle known in the art and the size of the pressure kettle may be selected for a desired batch size or as required for continuous processing and the particular pressure level desired. Furthermore, it should be appreciated that the pressure kettle may be constructed from any material that is suitable for contact with food and that will not chemically react with any constituent. For example, a stainless steel pressure kettle may be used. Preferably, a vacuum of approximately 27 in. Hg vacuum is applied. However, it should be appreciated that a vacuum of 6-29.5 in. Hg vacuum may be applied, or any suitable level that enhances processing, such as reducing hydration times. The vacuum may be applied by any device known in the art capable of operating in the vacuum range such as a vacuum pump 114. Suitable types of vacuum pumps include piston pumps, diaphragm pumps, liquid-ring pumps, rotary piston pumps and turbine pumps.

During the hydration period 210, optionally the constituent parts are mixed or otherwise agitated as illustrated in box 220. The term “agitation” should be understood to include mixing, turning, tumbling or vibrating. It can involve steady agitation, or alternatively one or more periods of agitation followed by rest. Optionally there is no agitation and the constituent parts are mixed in dry form as illustrated with box 60. In another alternative, there is both mixing of the dry constituent parts 60 and agitation 220 during the hydration period.

Another option during the hydration period is to add additional fluid ingredients 230. For example, additional water might be added. In another example milk, juice, chocolate, syrup, vanilla or fruit flavorings could be added. In another example, honey is added. These additional ingredients can be added at the same or different times during hydration 210 or alternatively before or after the hydration period 210.

A further option during the hydration period is to add solid ingredients 240, such as fruit, nuts, etc. Examples of suitable solid additions include strawberries, raspberries, blueberries, peaches, cherries, oranges, other citrus, mixed fruits and/or berries, raisins, crushed cookies or candy bars, chocolate pieces, candy pieces (such as M&M's a registered trademark of Mars, Inc., of McClean, Va.), other solid fruit flavorings, etc. It should be noted that these additions can be added singularly or in combinations. They can be added at the same or different times during hydration 210 or alternatively before or after the hydration period 210. It should be noted that it is preferred that in embodiments in which solid or liquid ingredients are optionally added during hydration, that agitation 220 also be performed. Where adding ingredients is discussed in this description it should be understood that they optionally can be mixed in by agitation (including mixing, turning, tumbling etc.) as discussed above.

Although it generally preferred that hydration be performed at room temperature, there are alternative embodiments as well. For example, partial cooking can be performed to partially cook some or all of the constituents. The partial cooking can be performed by heating or steaming.

At the end of hydration, either following the hydration period or around the end of the period, solid or fluid ingredients also can be added, as discussed already. This is diagrammatically illustrated with box 245 showing an input between hydration 210 and packaging 250.

Following hydration, the manufactured food product preferably is frozen 260 and subsequently distributed. The product can be frozen in bulk containers for subsequent to dividing it into any desired portions. Preferably packaging 250 occurs prior to freezing 260. The packages preferably include individual or multiple serving containers 150, which optionally can be microwaved for consumer preparation. Any type of container 150 can be used such as cups, sealable or resealable cups, bowls, plastic enclosures/bags, metal containers, etc. In a preferred embodiment, a plastic container 150 with a container body 151 and lid 152 is selected for packaging 250, and subsequent freezing 260. It should be noted that additional ingredients could be added prior to sealing the package, but after the hydrated mixture has been positioned within the package, including the solid and liquid additional ingredients discussed above, or optionally they can be added prior to packaging.

In one embodiment, the hydrated mixture is put in approximately half-pint individual size plastic containers 150, with lids 152 in the packaging step 250. Optionally a plastic film 153 is applied above the opening of the container and below the plastic lid, forming a sealed enclosure, although in some embodiments, the plastic film is not used. Other size plastic containers also can be used, such as 4, 6, 10, 12 and 16 ounce containers. An advantage of such frozen plastic containers 150 is that they are easily shipped to distribution points and ultimately retailers and consumers although other forms of containers also have such advantages.

In the frozen embodiment a consumer thaws the frozen product prior to consumption or optionally consumes in a semi-thawed state in which sufficient thawing allows for consuming bite size portions, such as with a spoon. Optionally, the consumer can thaw by applying heat from an external source and may optionally raise the temperature to an elevated level to have a “hot” cereal for consumption.

In another aspect of the present invention the hydrated mixture is stored in a container and lid that may be used both for freezing the hydrated mixture and microwaving the hydrated mixture. In such an embodiment, container 150 may be constructed from injection molded polypropylene or freezer grade polypropylene and lid 152 may be constructed from polyethylene, for example linear low density polyethylene.

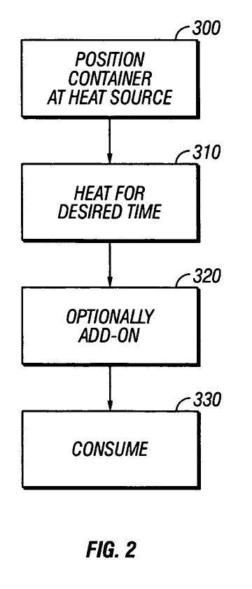

For example, as shown in FIG. 2, a consumer of the food product positions the frozen food product at a heat source 300. In one example, the food product is positioned in a microwave, although stove heating also can be selected. Then the consumer heats the product for a desired period of time 310, such as by running the microwave. This serves to thaw the product for consumption. Optionally it is heated to an elevated temperature to produce a hot food eating experience. Depending on the temperature and time of heating, gelatinization also can occur if desired, wherein starch particles gelatinize to form a gelatinous composition. Following thawing (or heating to elevated temperature), the previously frozen product is ready for consumption 330. Optionally an add-on, such as sweetener, nuts, fruit etc. can be added 320.

As described above a frozen food product is formed including at least one hydrated constituent part that is packaged and frozen prior to thawing and consumption. The frozen food product optionally includes plural hydrated constituent parts also optionally having different or similar digestion rates or rates of nutrition delivery, making a form of time released frozen food product.

Alternatively, freezing is not performed and the package is sealed in an air-tight fashion not requiring freezing. In this alternative embodiment, the product optionally is heated and stored in an air-tight container and thereby be packaged in a fluidized state. A consumer can open the container for consuming. In embodiments, where the food product is not frozen, the food product can be packaged in any desired way for distribution to consumers. For example it can be packaged in cartons or polymeric bags or wax coated paper bags etc. Alternatively it can be packaged for bulk purchase by consumers such as in a container from which a consumer can spoon out a desired amount. Alternatively it is not packaged, but is mixed and then prepared for eating.

Optional step 70, shown in FIGS. 3-8, is provided as an illustration of a preparation step of a food product in accordance with the present invention that has not been fully hydrated in the hydration period. It should be noted that only partial hydration might be performed in the hydration period in one embodiment. In that step water preferably is added in a desired proportion, and then in optional step 80 the food product is prepared for eating in some fashion. In one embodiment, step 80 is the hydration step and in others it is a heating step in which the mixture (either alone or in combination with water added in step 70) is elevated over boiling point for a period of time. It should be noted that in one or more of steps 70 and 80 or additional processing steps, other types of processing can be performed, such as to create or package cookies, nutrition or energy bars, cakes, pastries etc. In this embodiment, instead of cooking following addition of water 70, the product can be hydrated and frozen as illustrated in FIG. 1.

Other examples of the constituents (illustrated diagrammatically with reference numbers 20, 30, 40 and 50) include one or more steamed and/or pre-cooked versions of the constituents selected. For example, where the constituents are steamed and/or pre-cooked versions of the desired materials, the preparation time can be reduced. In one example, hydration time is reduced. In an alternative, after a mixture is formed (such as illustrated with reference number 60), the mixture can be steamed and/or pre-cooked and then hydrated and frozen.

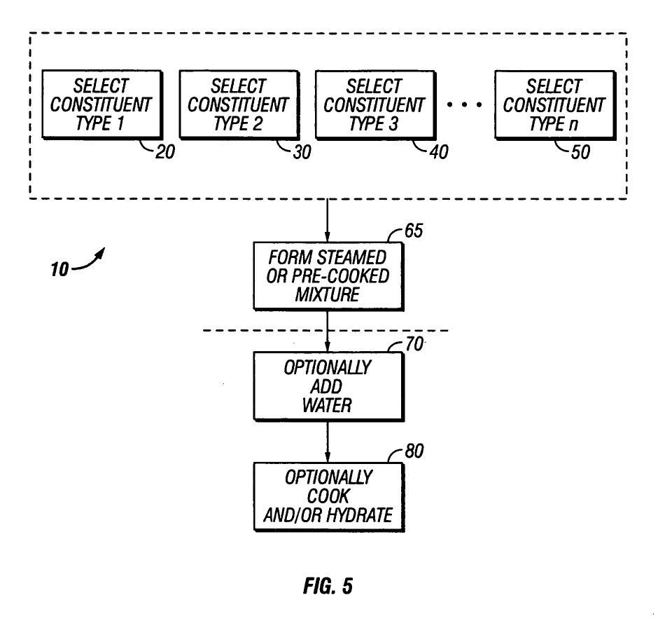

In FIG. 5, the steamed and/or pre-cooked mixture is illustrated with reference number 65. The steamed or pre-cooked mixture is formed, either by combining one or more steamed and/or pre-cooked constituents, as represented by reference number 20, 30, 40 and 50, or optionally selecting constituents that have not been steamed and/or pre-cooked, forming mixture 60, and then steaming and/or otherwise pre-cooking the mixture, as also illustrated with reference number 65.

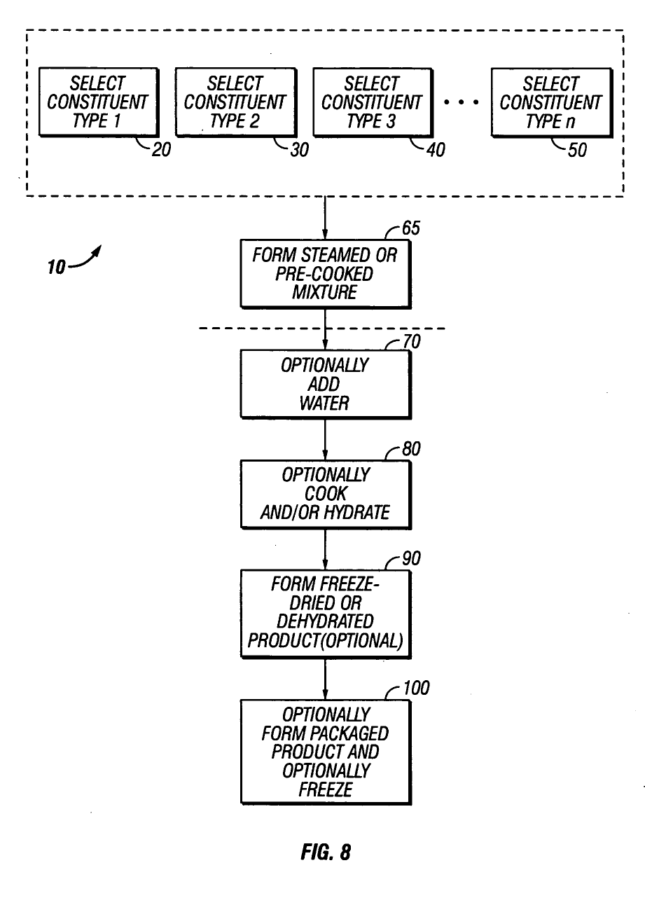

In another embodiment, the food product is prepared as illustrated with reference to FIG. 1 and then stored for consumption at a later time, such as by being freeze-dried or otherwise dehydrated after hydration (or full or partial cooking). In this way, the food product can be packaged or otherwise stored in the dehydrated form for consumption at a later time in which it can be rapidly re-hydrated for consumption by adding fluid and optionally heating. It should be noted that the freeze drying or dehydration can be performed either after full cooking 80 or hydration 200 or after the steamed or pre-cooked mixture 65 is formed, shown in FIG. 8.

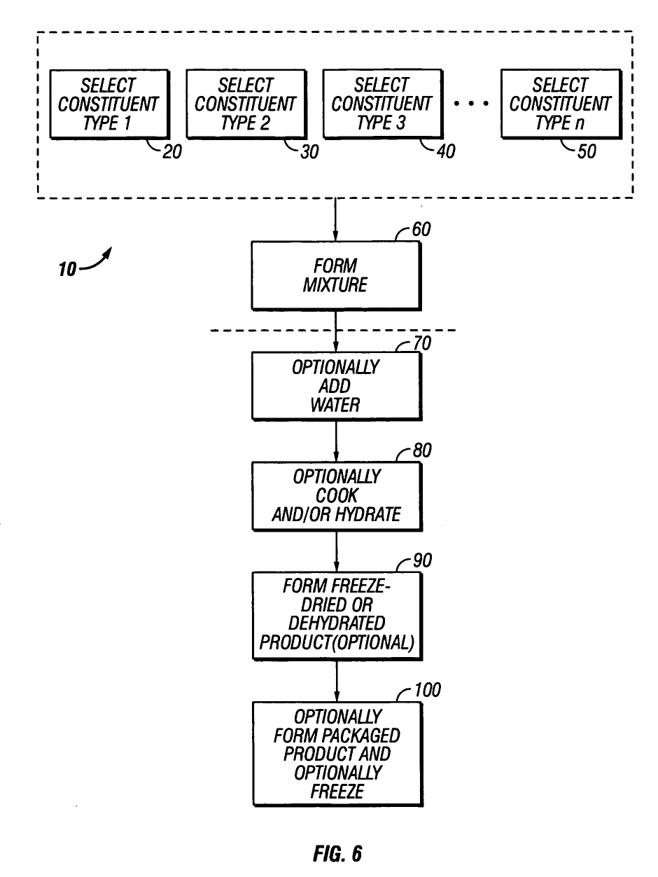

A freeze-dried product or dehydrated product 90 can be formed such as by any suitable methodology or apparatus for freeze-drying or dehydration. In FIG. 6 this is illustrated as a step of freeze-drying or dehydration. This produces a freeze-dried and hydrated food composition. Optionally as indicated in FIGS. 6 and 7, full or partial cooking can be performed in step 80 as well, although it is not required if hydration is performed via a hydration period. Optionally, other ingredients can be added as well. Optionally the product can be packaged, such as in individual serving pouches. Another alternative is to package as a Meal Ready to Eat, or “MRE”. In this way, the food product is packaged in its freeze-dried or dehydrated form such as for use by both consumers or for field personnel. Subsequently, the food product can be reconstituted relatively rapidly, such as by adding water or other suitable fluid such as milk, skim milk or juice as desired. The food product can be eaten as a hot or cold (ready-to-eat) cereal and be reconstituted using hot or cold fluids. The fluid can be heated before adding or added at room temperature, then optionally heated with direct heat source (stove, heat tab, etc.) or microwave oven. In one example, the reconstitution can take between 20 and 90 seconds.

Furthermore, other products can be formed of the food product such as grain bars, nutrition bars, candy bars, cereal bars, meal replacement bars, and other snack foods. It also can be used as a food additive or ingredient in other food items due to the reduction and/or elimination of the cooking process (heat and time). Using these methods, the digestion time and time-release benefits remain intact.

Advantageously, for preferred varied digestion rate grain based embodiments of the food product, the particle size is relatively large such as compared to instant grain cereals and other typical heated grain cereals so as to maintain a relatively low glycemic index. In this embodiment, the food product is a hot cereal with plural grain particles (as well as other optional food constituents as discussed herein).

Gelatinization can optionally occur during the cooking or heating steps, such as steps 310 and 80. This refers to the natural starch of at least one constituent part to convert by gelatinization and pasting, and can serve to coat the other constituents of the food product in a plasticized-like viscous liquid film. For example the natural starch of rolled oats converts into gelatinized starch that coats steel cut oats and whole oat groats. This causes the steel cut oats and whole oats to be more easily chewed and/or swallowed. However, if a sufficiently long hydration time is selected, the constituent parts also can be softened to enhance an eating experience.

Likewise, in the preferred embodiment, differing percentages of different constituent parts can be used. For example, one or more grain or seed can be used; likewise various forms of milling or other processing of the grains can be used. In one example, different forms of oats are used, although different grains can be used as well. In the oats-only embodiment, one or more types of rolled, steel cut, bumped oats and groats are used in desired percentages. Rolled oats are digested relatively quickly providing relatively quick time release of energy and nutrition to the user. Steel cut oats are digested at a slower rate and over a medium length of time. Groats are processed via digestion over a longer period of time thus providing extended nutrition and energy. In this example, to consume, a mixture of the constituent parts of different forms of oats are combined with water and hydrated over a period of time. Likewise other food constituents can be added in, such as dried fruit, whole nuts, chocolate, etc. Only a single length of time needs to be used, as the constituent parts are hydrated together in this example.

Examples of food products in accordance with the invention will be discussed below. It should be understood that these merely are examples of preferred embodiments, but other combinations of different constituent parts, and preparation procedures also may be used. It should be understood that in the examples that follow, the amounts are provided to show proportionality, and not limitation on the batch size. Any desired batch size can be selected.

### EXAMPLE 1

It should be understood the amounts are provided to show proportionality, and not limitation on the batch size.

A fresh frozen breakfast cereal with fruit is made as follows:

Hydrate (i.e. soak) 50 g of grain and/or seed constituents for 10 to 12 hours (turn over 2 times) in ⅓ cup+1 TBSP (Tablespoon) of water, or for approximately 30 minutes under vacuum pressure;

Add 1 TSP (Teaspoon) non-fat dry powdered milk and then mix

Add 1 TSP (Teaspoon) honey and then mix;

Add ⅓ cup frozen fruit and then mix; and

Freeze in one or more containers.

Alternatively add the powdered milk, honey and frozen fruit at the same time and then mix, or add different combinations of them followed by mixing. In one embodiment, the grain and/or seed constituents include one or more forms of oats. In addition, maple syrup and/or evaporated organic cane juice may also be added to add further sweetening.

Numerous variations can be practiced. For example, a plain oat cereal with honey may be created with hydrated oats, honey, maple syrup, evaporated organic cane juice, non-fat dry milk and natural flavors. In addition, a mixed berry cereal may be created with hydrated oats, a berry blend (e.g., blueberries, blackberries, raspberries and strawberries), honey, maple syrup, evaporated organic cane juice, non-fat dry milk and natural flavor. In a further example, a peach cereal may be created with hydrated oats, natural peaches, honey, maple syrup, evaporated cane juice, non-fat dry milk and natural flavors. In a still further example, an apple and cinnamon cereal may be created with hydrated oats, natural apples, honey, maple syrup, evaporated organic cane juice, non-fat dry milk, cinnamon and natural flavors. A strawberry, blueberry or cherry cereal may also be created using hydrated oats, a respective natural fruit; honey, maple syrup, evaporated organic cane juice, non-fat dry milk and natural flavors. In another example, a cocoa cereal may be created using hydrated oats, evaporated organic cane juice, real semi-sweet chocolate chips, non-fat dry milk, cocoa and natural flavors. Furthermore, a sports nutrition cereal may be created using hydrated oats, whey protein, honey, maple syrup, evaporated organic cane juice, non-fat dry milk and natural flavors.

### EXAMPLE 2

A fresh frozen soup such as vegetarian chili oats with beans and tomato is made as follows:

Hydrate (i.e. soak) 50 g of grain and/or seed constituents for 10 to 12 hours (turn over 2 times) in ⅓ cup+1 TBSP (Tablespoon) of water, or for approximately 30 minutes under vacuum pressure;

Add 1 TSP (Teaspoon) dry chili powder or other chili seasonings and then mix;

Add ⅛ TSP (Teaspoon) table salt and then mix;

Add 1 TSP (Teaspoon) honey and then mix;

Add 1 TBSP (Tablespoon) tomato paste and then mix;

Add ⅓ cup rinsed dark red kidney beans (pre-hydrated) and then mix;

Add ⅓ cup tomato sauce and then mix; and

Freeze in one or more containers.

Alternatively add the chili powder, salt, honey, tomato paste, beans and tomato sauce at the same time and then mix, or add different combinations of them followed by mixing. In one embodiment, the grain and/or seed constituents include one or more forms of oats.

Numerous variations can be practiced. For example, a vegetarian Mexican chili may be created by substituting pinto beans for the kidney beans and adding taco seasoning. In addition, a vegetarian enchilada chili may be created by using black beans and taco seasoning and adding corn. In a further example, vegetarian California chili may be created using white beans and taco seasoning and by adding whole green peas. In a still further example, a vegetarian five bean chili may be created using a five bean blend (e.g., red kidney, pinto, black, navy and great northern beans) and taco seasoning and by adding mixed vegetables such as whole green peas, whole yellow sweet corn, green beans and carrots. It should be appreciated that the variations of the vegetarian chili recipes described above may be used as a filling in burritos and wraps (such as by wrapping the composition in a tortilla, rice paper, flat bread, etc.) with or without cheese.

### EXAMPLE 3

A fresh frozen soup such as a chicken, oats and vegetable soup is made as follows:

Hydrate 50 g of grain and/or seed constituents for 10 to 12 hours (turn over 2 times) in ⅓ cup+1 TBSP (Tablespoon) of water, or for approximately 30 minutes under vacuum pressure;

Add ⅓ cup frozen or unfrozen mixed vegetables;

Add ⅛ TSP (Teaspoon) salt;

Add 99% fat free chicken broth as desired, such as 9.5 oz.;

Mix; and

Freeze in one or more containers.

Alternatively mixing can be performed following one or more of the adding steps. In one embodiment, the grain and/or seed constituents include one or more forms of oats.

### EXAMPLE 4

A fresh frozen soup such as beef and vegetables is made as follows:

Hydrate 50 g of grain and/or seed constituents for 10 to 12 hours (turn over 2 times) in ⅓ cup+1 TBSP (Tablespoon) of water, or for approximately 30 minutes under vacuum pressure;

Add ⅓ cup frozen or unfrozen mixed vegetables;

Add ⅛ TSP (Teaspoon) salt;

Add 99% fat free beef broth as desired such as 9.5 oz.;

Mix; and

Freeze in one or more containers.

Alternatively mixing can be performed following one or more of the adding steps. In one embodiment, the grain and/or seed constituents include one or more forms of oats.

### EXAMPLE 5

A cereal product is formulated as follows:

½ cup of rolled oat flakes
(One half of each mill type: ¼ cup of 0.033″ and ¼ cup of 0.037″ rolled oats)

3 tablespoons of Steel Cut Oat Groats

2 tablespoons of Bumped Oat Groats

2 tablespoons of Whole Oat Groats.

In order to prepare for eating, about 2¼ cups of water can be added to the mixture and the mixture is hydrated for 5-15 hours, or for substantially less time under vacuum pressure. The hydrated cereal optionally can be eaten at room temperature or alternatively heated. Also optionally, it can be packaged for further distribution after hydration, such as by freezing and stored in freezable and optionally microwavable containers.

Numerous variations can be practiced. For example, fresh frozen, dried or dehydrated fruit can be pre-packaged with the mixture. Alternatively, it can be added during preparation for eating. For example, ¼ cup of frozen fruit is added. Examples of fruit include raisins and dried or dehydrated cranberries, blueberries, peaches, pineapples, cherries, etc. Nuts can be added as well.

Other variations include adding milk, or sweetener such as natural sweeteners like sugar, syrup or honey, or artificial sweeteners like aspartame, sucralose (such as SPLENDA brand sweetener, a registered trademark of McNeil Nutritionals, LLC of Fort Washington, Pa.) or saccharine.

### EXAMPLE 6

A cereal product is formulated as follows:

½ Cup of rolled oats

3 Tablespoons of whole oat groats

2 Tablespoons of steel cut oats

In order to prepare for eating, about 2 cups of water can be added for a hydration period. Optionally, it could be packaged for further distribution after being hydrated, such as being packaged and optionally frozen. It should be noted that the variations described above with respect to Example 5 apply equally as well to Example 6 and other embodiments as well.

### EXAMPLE 7

Another embodiment of soup such as a chili oats with beans is made as follows:

Brown 1 cup of lean ground beef in a saucepan;

Add 1 chopped onion to saute with the beef;

Add 2-3 Tablespoons of chili seasoning mix and stir mixture;

Add 14 oz. of beef broth and bring mixture to a boil;

Add 10 g of grain and/or seed constituents;

Add 15 oz. of tomato sauce;

Add 10.75 oz. of condensed tomato soup;

Add 1-2 cans of drained kidney beans; and

Bring mixture to a rapid boil then lower heat and allow to simmer for 17 minutes.

It should be appreciated that from the above recipe the dry ingredients may be packaged and sold with the recipe for producing the soup printed thereon.

Additionally, constituents of the soup recipe listed above may be substituted to create additional embodiments. For example, a bean stew may be created using beef stew seasoning in place of the chili seasoning. Similarly, a tex-mex soup may be created by substituting taco seasoning for the chili seasoning. In another embodiment, a navy bean recipe may be created by substituting navy beans for the kidney beans and by substituting navy bean/ham seasoning for the chili seasoning. In a still further embodiment, a vegetable soup may be created by substituting chicken broth for the beef broth and substituting chicken soup seasonings for the chili seasoning. In addition, Cuban black bean soup may be created using black beans instead of kidney beans and by adding onions and sour cream. It should also be appreciated that variations of the frozen soup or stew recipes may be used for a filling in microwaveable frozen burritos and frozen wraps (such as by wrapping the composition in a tortilla, rice paper, flat bread, etc.). It should further be understood that the food composition of the present invention may be used generally as a meat extender.

### EXAMPLE 8

It should be understood the amounts are provided to show proportionality, and not limitation on the batch size.

A sports nutrition frozen breakfast cereal may be made that may be heated to provide a cereal that provides both protein and complex carbohydrates that offers a complete balanced meal. The sports nutrition breakfast cereal is made as follows:

Hydrate (i.e. soak) 50 g of grain and/or seed constituents for 10 to 12 hours (turn over 2 times) in ⅓ cup+1 TBSP (Tablespoon) of water, or for approximately 30 minutes under vacuum pressure;

Add 1 TSP (Teaspoon) non-fat dry powdered milk and then mix

Add 1 TSP (Teaspoon) honey and then mix;

Add a desired amount of heat resistant whey protein powder; and

Freeze in one or more containers.

It should be appreciated that the protein may be added to the food composition in any form known in the art. Preferably, protein is added in the form of heat resistant whey protein. The product may be provided in frozen form and may be microwaved prior to eating and the use of heat resistant whey protein may prevent degradation of the protein caused by heating. The protein may be added in the form of a powder or another solid form such as protein solids in the shape of wafers, spheres, crisps or any other shape with piece identity known in the art. The protein may be added to the food composition prior to or after hydration. It should also be appreciated that fruit also may be added to the sports nutrition cereal.

It should be noted that depending on the particular recipe or individual taste other amounts of the different ingredients in the above examples food composition can be used and the above examples are not meant to limit the scope of the invention herein, but only are provided as some of the numerous possibilities. Likewise, the particular brands of ingredients are provided only as examples, and other brands or sources can be used. The amounts are provided only as examples of particular food products that can be prepared, sold, or otherwise packaged and distributed, of a food product incorporating the food composition of the present invention. In addition, hydration as mentioned in the above examples can also be shortened by using partial pre-cooking or steaming, or can be eliminated by pre-cooking. In some embodiments, hydration is not performed, such as when pre-processed dry grain constituents are used—such as cereal flakes.

Continuing with a general description of the invention, an example of a time released food composition in one embodiment provides the constituent part (such as rolled oats) that is digested relatively quickly, typically over about an hour or two in Examples 1 or 2 above. A “medium” release constituent (such as steel cut oats) is digested over a medium amount of time, such as about three to four hours in Examples 1 or 2. A “long” time release constituent (such as whole grain oats, groats etc.) is digested over an extended period, such as about five to eight hours. It should be understood that these time ranges of digestion are an example only to illustrate the short, medium and long time release rates. Actual time release-or digestion rates in different individuals will vary.

In addition, by preserving a high fiber content in the ingredients other benefits are achieved, such as slowing the digestion of other foods eaten after the mix/blend is ingested, due to the absorption properties of the fiber. The high water absorption by the fiber tends to fill the gut without gas bloating and reduces appetite and food consumption as a result.

It should be understood that the food product of the present invention can be used to manage blood glucose response/levels by using a selected blend of time released (i.e. varying rates of digestion) carbohydrates, such as necessary for good nutrition of persons having diabetes. One way of ranking carbohydrate foods on how quickly carbohydrates enter the bloodstream and elevate blood sugar is a glycemic index (GI). Quickly digested and metabolized carbohydrates have the highest glycemic indexes. Their blood sugar or glucose response is fast and high. Slowly digested carbohydrates have low glycemic indexes and release glucose gradually into the bloodstream. Their blood sugar or glucose response is slow and steady.

It is understood that diets with a low glycemic load may be useful in preventing or regulating diabetes and coronary heart disease. In general, refined, starchy foods have a relatively high glycemic index. The food composition of the present invention can be selected to provide a low glycemic index, while also being high in fiber (especially viscous fiber), having some starch that resists gelatinization, while also having other starch that gelatinizes, is digested at varying rates, and contains phytonutrients that slow digestion and absorption. When the food composition is eaten, it is understood that one benefit is that it provides both a time released carbohydrate and it slows the digestion and glycemic response of high-glycemic foods eaten at the current meal or the next meal eaten at a later time, acting like a fiber sponge that absorbs the shock and delays the release to slow digestion. Not only is the glycemic index affected by other components of a meal, it is also affected by food selections at prior meals. For instance, inclusion of the food composition of the present invention at a preceding meal can act to lower the glycemic index of a carbohydrate food in a later meal. This is called a lente carbohydrate effect. In addition, it is understood that ingestion of a food with either a low or moderate glycemic index prior to exercise improve can improve endurance, a further advantage of the present invention.

Slowly released starches, such as those in some forms of oatmeal, tend to have low glycemic indexes, even if they are fully digested and have been found to be useful to add to the diet of diabetics for regulating blood glucose levels. The larger and more intact the particle size, the lower the glycemic index. Thus, in selecting the constituent parts of the food composition of the present invention it is desired to include at least a portion of constituent(s) that provide a relatively low glycemic index.

It is understood that a reduction in diabetic side effects can be achieved with the regular selection of starchy foods with relatively moderate or low glycemic indices. An example of one such side effect is elevated blood lipid levels. This reduction of diabetic side effects is provided by the food composition of the present invention and in addition, the food composition improves the entire health of an individual's diet by counter balancing the effect of a high-glycemic diet. The health effect is realized by adding the food composition of the present invention to an individual's diet and not necessarily by requiring the individual to restrict the intake of other foods that he or she desires. It is understood that current research has shown low-glycemic index foods such as the food composition of the present invention can provide, results in relatively lower fluctuations in blood sugar levels and improve to the sensitivity to insulin with the ultimate goal of better blood sugar control in people with insulin resistance and diabetes.

Furthermore, the present invention can be used for weight loss, such as a diet supplement, that may be used to lose weight or control obesity. In operation by providing a timed release of nutrients, including carbohydrates or other sources of nutritional energy, it helps prevent the onset of a hungry feeling in an individual. It assists with this appetite control by providing a relatively level, steady blood sugar/glucose supply and filling the gut with fiber to provide a sense of fullness and satisfaction without overeating. Obesity and low intake of fiber amplify the adverse consequences of high-glycemic load. Consumption of the food composition of the present invention adjusted for a low-glycemic index can lower blood lipids in both diabetics and non-diabetics with elevated blood lipids, and can also be useful in weight loss.

The present invention provides a low-glycemic level, very high fiber, high starch resistance, long/slow digestion time, steady and level carbohydrate delivery or availability.

Viewed another way, one cause of weight gain or obesity is overconsumption of food caused by addressing a feeling of hunger (with all the unpleasant side effects of lightheadedness, irritability, lack of energy, etc.) by eating. The food composition of the present invention provides a diet formula or supplement that allows for weight loss, while still feeling full, or at least not feeling hungry. This is achieved at least in part by the time release property of the food composition. One explanation for the overconsumption of food leading to undesirable or undesired weight gain is a difficulty regulating blood glucose/sugar level—such as can result from a low fiber and/or high glycemic index diet. Such a diet results in an increase in blood glucose level soon after eating. A metabolitic reaction is to respond with relatively high discharges of pancreatic insulin into the blood to drive down the blood glucose level down. Insulin stimulates the body's cells to remove sugar from the bloodstream and utilize it. Next, the body responds with the discharge of glucagon. Glucagon has the opposite effect of insulin and acts as a control mechanism when the body produces too much insulin. It is the lag time effect of this process caused by the shock of low fiber, high glycemic foods that crashes the blood sugar below the fast fasting level. Because of the metabolitic reaction to the consumption of high GI foods, many overweight or obese people can feel hungry again shortly after having eaten, resulting in a cycle of overeating.

Moreover, since the pancreas produces both the insulin and glucagon can become diseased or fail from the roller coaster of insulin and glucagons production, resulting in a frequent form of diabetes (Type II).

The food composition of the present invention provides a high fiber, low glycemic food or meal that delivers a slow, level, and steady stream of complex carbohydrates and nutrients to the consumer. This helps the consumer to regulate his or her blood glucose/sugar and get off the hunger “roller coaster”. The present invention thereby allows a desired level of food consumption avoiding a feeling of hunger, while also reducing the desire for further food intake.

Examples 5 and 6 are examples of an oat blend embodiment that can reduce or eliminate a feeling of hunger for an extended period of time, such as for 5-8 hours and has an additional benefit of providing a substantially even, level blood glucose response. This is very useful for people with diabetes and/or obesity. In addition, it is useful for athletes, persons desiring weight loss, and busy/active people that have time to eat one meal, but need it to carry them through for 5 to 8 hours with energy and clarity of thought from steady and level blood glucose.

In another view, the food product can be considered a carbohydrate dosage delivery system that regulates blood glucose levels/response over an approximately 5 to 8 hour period or a more extended period such as for example 3-48 hours, or longer, due to its formulation and servings size (dosage). An example of a use of such a system is for use by diabetics in regulating blood glucose level. Another use is as a type of diet or dieting supplement, which when eaten can reduce a desire to eat by providing an extended or time released carbohydrate (and other nutrition and energy) delivery providing a feeling of fullness over an extended period of time.

It should be appreciated that the food composition of the present invention may be incorporated into a wide variety of food products. For example, it may be incorporated into frozen breakfast cereal with or without real fruit, nuts or other added flavorings. For example, it may be used for oats with strawberries, mixed berries (such as blueberries, blackberries, raspberries and/or strawberries), blueberries, cherries, apples with cinnamon, peaches an/or banana slices with chocolate. It may also be incorporated into fresh frozen soups, as described above, soup seasoning packages or burrito fillings. It may also be incorporated into a refrigerator case product such as a cold ready-to-eat fresh oat product or freezer case products designed to be thawed and eaten. Examples of refrigerator and freezer case products include cookies (such as nutrition or energy cookies), hydrated oatmeal, frozen cookie dough, fresh bread dough, bagel dough, pizza dough, fresh soft pretzels, tortillas, muffins, frozen waffles, frozen pancakes, breakfast bars with or without real fruit, granola bars with or without real fruit, granola, oat cluster snacks, cold box cereal, chips, crackers, bread, cakes, cup cakes, pies, hand pies, pudding (e.g., tapioca), yogurt, frozen veggie burgers, rice pilaf, risotto or fresh grain meal/snack tubes (e.g., flexible plastic squeeze-type tube).

As described above, the food composition of the present invention may also be used to create nutrition bars or cereals. For example, protein may be added to the food composition such as in the form of heat resistant whey protein. The addition of protein creates a product that offers a complete balanced meal of protein and complex carbohydrates. The product may be provided in frozen form and may be microwaved prior to eating. The protein may be added in the form of a powder or another solid form such as protein solids in the shape of wafers, spheres, crisps or any other shape with piece identity known in the art. The protein may be added to the food composition prior to or after hydration.

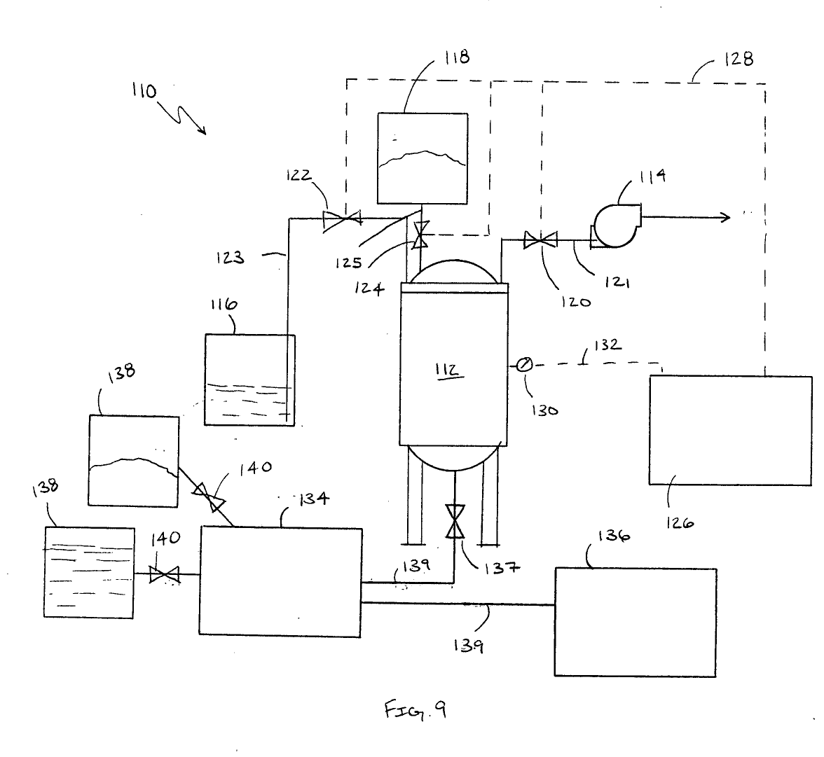

Referring to FIG. 9, an example of a hydration apparatus 110 for performing a pressure-modified, or vacuum hydration process will be described which allows the food composition to be “cold-processed and wet” (i.e., hydrated and processed without the application of heat). Apparatus 110 generally includes a pressure kettle 112 that is in communication with a vacuum pump 114, at least one liquid source 116 and at least one constituent source 118 through respective material transport conduit 121, 123, 125. Any form of material transport conduit can be used that is capable of conveyance of the subject material to the desired location. These can include apparatus for transport or alternatively manual transport. Vacuum pump 114 communicates with pressure kettle 112 through a vacuum valve 120 via conduit 121 and is provided to pump down the pressure within pressure kettle 112 from ambient pressure to a pressure in the range of 6-29.5 in. Hg vacuum. As mentioned above, vacuum pump 114 may be any apparatus that is capable of modifying a pressure level within kettle 112.

Liquid source 116 is configured to provide a liquid, which is used during the hydration process to hydrate a relatively dry constituent, to pressure kettle 112. Liquid source 116 may be any container that is capable of holding fluid. As shown, liquid source 116 is a bulk container that communicates with pressure kettle 112 through liquid valve 122 via conduit 123. It should be appreciated that for small batches or a small number of batches, an operator may manually measure and add liquid to pressure kettle 112, add a pre-measured portion of liquid to pressure kettle 112 or manually operate liquid valve 122 to release a desired volume of liquid.

The dry constituent is provided to pressure kettle 112 from a constituent source 118. Constituent source 118 may be any container that is capable of holding dry constituents. For example, constituent source 118 may be a hopper that holds a dry constituent or a mixture of dry constituents in bulk. Constituent source 118 communicates with pressure kettle 112 through conduit 125 and a constituent valve 124 that is used to regulate flow of the constituent to pressure kettle 112.

Apparatus 110 may also include a mixing chamber 134 and/or a packager 136 that communicate with pressure kettle 112 through a valve 137 and a transport member 139. Mixing chamber 134 is configured to allow the addition of additional ingredients subsequent to the hydration process. As shown, mixing chamber 134 may communicate with a plurality of bulk containers 138 through valves 140 and it should be appreciated that bulk containers 138 may store liquid or dry ingredients as desired. Packager 136 may also be included so that the hydrated components and any additional ingredients added in mixing chamber 134 may be packaged. Packager 136 may be configured to package the mixture in single serving or bulk packaging as desired. It should also be appreciated that transport member 139 may be any device known in the art capable of transporting the hydrated mixture. For example, transport member 139 may be a conveyor system, a pressure system driven by pressure or vacuum, a screw system, gravity or any combination thereof.

Preferably, the food composition is packaged and frozen immediately after the “cold-processed and wet” manufacturing process described above so that the food composition is not over processed or chemically broken down by any cooking or heating. The cold process is also preferred to protect live enzymes and micro-organisms that may be beneficial to human health that may otherwise be destroyed by cooking or heating. In addition, freezing immediately after the “cold-processed and wet” manufacturing process maintains any enzymes and/or micro-organisms in a state of suspended animation (i.e., maintains them in their state immediately after processing). As a result, the cold process creates a more healthy, natural and better tasting food composition. It should be appreciated, however, that any aseptic packaging technique may be employed such as retort and hot-fill canning and flash-heating-and-cooling.

Apparatus 110 also includes a controller 126 that may be used to control operation of valves 120, 122, 124, and vacuum pump 114 so that the hydration process may be performed automatically or controlled remotely through communication links 128 between the components and controller 126. In an embodiment, controller 126 sends an open signal to constituent valve 124 so that constituents in constituent source 118 are released into pressure kettle 112. Next, controller 126 sends a signal to vacuum pump 114 to reduce the pressure in pressure kettle 112. After the pressure in pressure kettle 112 is reduced, that reduced pressure may be used to draw liquid into pressure kettle 112 by opening liquid valve 122 with an open signal from controller 126. After a desired quantity of liquid and dry constituent is provided to pressure kettle 112, valves 122 and 124 are preferably closed and operation of vacuum pump 114 is continued until a desired vacuum pressure is achieved within pressure kettle 112 as determined by a pressure sensor 130. Pressure sensor 130 may be any type of pressure sensor known in the art that is located within pressure kettle 112 or vacuum conduit 121 (preferably between valve 120 and pressure kettle 112). Preferably pressure sensor 130 communicates with controller 126 through a communication link 132. Controller 126 may also include a timer that is used to determine when the hydration process is complete. It should be appreciated that pressure kettle 112 may also be configured so that its contents may be removed in an automated process after completion of the hydration process. It should further be appreciated that pressure kettle 112 may also include an agitator that allows mixing of the constituent parts and liquid during the hydration process.

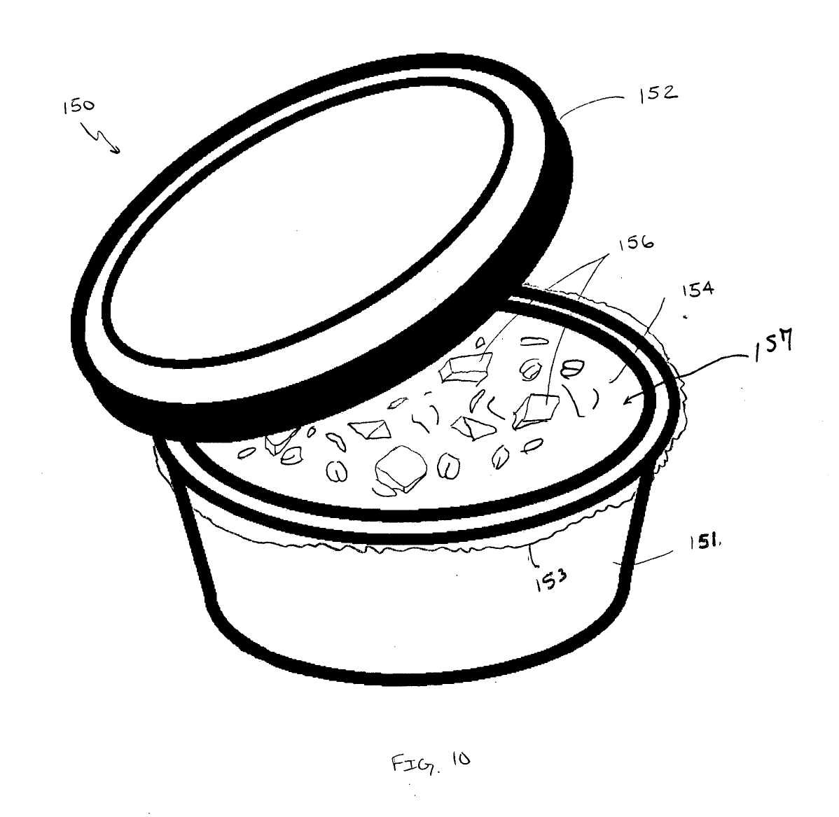

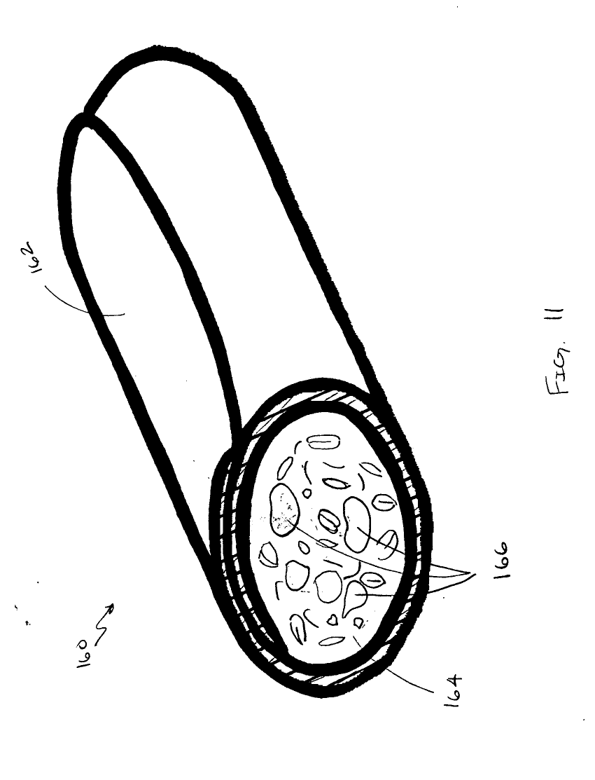

Referring to FIGS. 10 and 11, embodiments of the food product will be described. As described above, the hydrated mixture and any additional ingredients may be packaged and optionally cooled or frozen. In an embodiment, shown in FIG. 10, the mixture is provided in a single serving container 150 that includes a bowl-shaped body 151, a lid 152 that seals shaped container 150, and an optional an plastic film 153 that is positioned across and sealing an opening 157 of the body 151, and is between the upper edge of the body 151 and the inside of lid 152 once the lid is positioned on the body. Container body 151 may be filled with a single serving portion of the hydrated mixture 154 and any additional ingredients 156, such as fruit. Then lid 152 may be attached and the closed container 150 optionally may be frozen or otherwise stored. It should be appreciated that although a single serving size portion is preferred, any sized portion may be stored and/or frozen in a closeable package. It should be appreciated that packager 136 can be an automated system coordinating the positioning of the hydrated components 154 and any other ingredients 156 (either pre-mixed or not pre-mixed) in the containers 150, and for subsequent shipment to markets.

A burrito embodiment is shown in FIG. 11. Burrito, or wrap, 160 includes a tortilla 162, or other wrapping member such as rice paper or flatbread, hydrated mixture 164 and any additional ingredients, such as beans 166. It should be appreciated that the burrito may be wrapped in tortilla 162 in any method known in the art. For example, burrito 160 may be wrapped so that the ends are open or closed.

Thus, it is seen that a hydrated and then frozen food product, optionally providing differing rates of digestion and nutrition delivery is provided. One skilled in the art will appreciate that the present invention can be practiced by other than the above-described embodiments, which are presented in this description for purposes of illustration and not of limitation. The description and examples set forth in this specification and associated drawings only set forth embodiment(s) of the present invention. The specification and drawings are not intended to limit the exclusionary scope of this patent document. Many designs other than the above-described embodiments will fall within the literal and/or legal scope of the following claims, and the present invention is limited only by the claims that follow. It is noted that various equivalents for the particular embodiments discussed in this description may practice the invention as well.

What is claimed is:

1. A method of hydrating a food composition comprising:
forming constituent parts including at least one processed grain or seed;
adding fluid to the constituent parts to form a mixture;
applying vacuum pressure to the mixture within a pressure kettle; and
maintaining the vacuum pressure on the mixture during a hydration period for a sufficient period of time to hydrate the constituent parts.

2. The method of hydrating a food composition of claim 1, wherein the step of applying vacuum pressure includes a vacuum pressure in the range of 6-29.5 in. Hg vacuum.

3. The method of hydrating a food composition of claim 1, wherein the hydration period is approximately 30 minutes long.

4. A method of manufacturing a food composition comprising:
forming constituent parts;
adding liquid to the constituent parts;
applying vacuum pressure to the combined constituent parts and liquid;
waiting during a hydration period a sufficient period to hydrate the constituent parts; and
forming a food product with the hydrated constituent parts.

5. The method of manufacturing a food composition of claim 4 further comprising the step of freezing the food product.

6. The method of manufacturing a food composition of claim 4 further comprising the step of refrigerating the food product.

7. The method of manufacturing a food composition of claim 4, wherein the step of forming a food product includes forming at least one of cookies, nutrition bars, breakfast bars, waffles, bread dough, pizza dough, bagel dough and veggie burgers.

8. The method of manufacturing a food composition of claim 4 wherein heat is applied during the hydration period.

9. The method of manufacturing a food composition of claim 4 wherein forming the constituent parts includes:
selecting a first constituent part having a first nutrition delivery rate when hydrated; and
selecting a second constituent part having a second nutrition delivery rate when hydrated.

10. The method of manufacturing a food composition of claim 9 wherein forming the constituent parts further includes mixing the first and second constituent parts.

11. The method of manufacturing a food composition of claim 4 further comprising the step of mixing the liquid and constituent parts after the step of adding liquid.

12. The method of manufacturing a food composition of claim 5 further comprising adding additional ingredients prior to freezing.

13. The method of manufacturing a food composition of claim 12 wherein the additional ingredients include at least one of fruit, nuts and chocolate.

14. The method of manufacturing a food composition of claim 5 further comprising the step of packaging the food product before the step of freezing.

15. The method of manufacturing a food composition of claim 14 wherein the step of packaging includes positioning the food product in an individual serving container.

16. A method of manufacturing a food composition;
selecting a first constituent part;
processing the first constituent part by a first process;
selecting a second constituent part;
processing the second constituent part by a second process that is different from the first process;
combining the constituent parts;
adding liquid to the constituent parts;
applying vacuum pressure to the combined constituent parts and liquid;
waiting during a hydration period a sufficient period to hydrate the constituent parts; and
forming a food product with the hydrated constituent parts.

17. The method of manufacturing a food composition of claim 16 further comprising the step of at least partially cooking the constituent parts prior to adding liquid.

18. The method of manufacturing a food composition of claim 16 further comprising the step of freeze-drying the hydrated constituent parts.

19. The method of manufacturing a food composition of claim 16 further comprising the step of dehydrating the hydrated constituent parts.

20. The method of manufacturingg a food composition of claim 16 further comprising the step of packaging the food product.

21. A packaged food product, comprising:
a container including a container body and lid; and
a predetermined portion of a food composition disposed in the container body, the food composition including at least hydrated grains.

22. The packaged food product of claim 21 wherein the hydrated grains comprise ambient-hydrated grains.

23. The packaged food product of claim 21, wherein the container body is bowl-shaped, cup-shaped, or a flexible tube.

24. The packaged food product of claim 21, wherein the food composition is frozen.

25. The packaged food product of claim 21 wherein the food composition further includes fruit mixed with the hydrated grains.

26. The packaged food product of claim 25, wherein the fruit is one of cherries, strawberries, blueberries, apples.

27. The packaged food product of claim 21 wherein the food composition further comprises a sweetener.

28. The packaged food product of claim 27, wherein the sweetener is one of sugar, brown sugar, syrup, honey, aspartame, sucralose and saccharine.

29. The packaged food product of claim 21, wherein the food composition further comprises beans.

30. The packaged food product of claim 21 wherein the predetermined portion is a single serving portion.

31. The packaged food product of claim 21 wherein the predetermined portion includes multiple single serving portions.

32. The packaged food product of claim 21 wherein the ambient-hydrated grain includes a plurality of types of grains or seeds.

33. The packaged food product of claim 21 wherein the hydrated grains include a single type of grain or seed processed in at least two ways.

34. The packaged food product of claim 21, wherein the food composition is formed as at least one of soup, pre-prepared breakfast cereal, cookies, an energy bar, a nutrition bar, a waffles, cookies, oatmeal, cookie dough, bread dough, bagel dough, pizza dough, fresh soft pretzels, tortillas, muffins, waffles, pancakes, breakfast bars with or without real fruit, granola bars with or without real fruit, granola, oat cluster snacks, chips, crackers, bread, cakes, cup cakes, pies, hand pies, pudding, tapioca, yogurt, frozen veggie burgers, rice pilaf, risotto or fresh grain meal/snack tubes.

35. The packaged food product of claim 21, wherein the container body and lid are plastic, and wherein the container is configured such that the food composition may be frozen and microwaved therein.

36. A packaged soup product, comprising:
a container including a container body;
a predetermined portion of hydrated grains disposed in the container body; and
soup seasonings disposed in the container body; and
wherein the hydrated grains and soup seasonings are frozen.

37. The packaged soup product of claim 36 further comprising beans disposed in the container body.

38. The packaged soup product of claim 37 wherein the soup seasonings are chili seasonings.

39. The packaged soup product of claim 38, wherein the soup seasonings are taco seasonings.

40. A frozen burrito, comprising:
an edible wrapping member; and
a predetermined portion of hydrated grains wrapped in the wrapping member,
wherein the edible wrapping member and the hydrated grains are frozen.

41. The frozen burrito of claim 40, wherein the wrapping member is a tortilla.

42. A packaged food product, comprising:
a container including a plastic container body and plastic lid; and
a predetermined portion of a food composition disposed in the container body,
wherein the container is configured so that the food composition may be frozen and microwaved therein.
